(19) United States
(12) Patent Application Publication
(10) Pub. No.: US 2012/0030132 A1
(43) Pub. Date: Feb. 2, 2012

(54) SHIPPING INSTRUCTION DETERMINATION SYSTEM

(75) Inventors: NORITOMO OUCHI, Sagamihara (JP); Jun Tateishi, Tokyo (JP)

(73) Assignee: Hitachi, Ltd.

(21) Appl. No.: 13/019,034

(22) Filed: Feb. 1, 2011

(30) Foreign Application Priority Data
Jul. 27, 2010 (JP) 2010-167675

(51) Int. Cl. G06Q 10/00

(52) U.S. Cl. 705/330

(57) ABSTRACT

A shipping instruction determination system provides a storage device which stores a shipping request in a supply destination, a supply available schedule of a supply source, information of a packaging form indicating a combination of products and its number of units to be able to be packed in packaging boxes to be used for a shipment and a physical distribution cost for every packaging form, and a shipping instruction calculation unit which calculates a combination, a physical distribution cost of which becomes minimum, of a shipping date, the number of shipping units and a packaging form from among the shipping available combinations of the shipping date, the number of shipments and the packaging form, from the shipping request, the supply available schedule, the information of packaging form and the physical distribution cost for every packaging form to determine a shipping instruction.

### INCORPORATION BY REFERENCE

The present application claims priority from Japanese application JP2010-67675 filed on Jul. 27, 2010, the content of which is hereby incorporated by reference into this application.

### BACKGROUND OF THE INVENTION

The present invention relates to a system and a method for determining a shipping date, number of shipping units and a packaging form as a combination of products and its number of units to be packed respectively in packaging boxes when instructing the shipping of goods/products to a supply destination from a supply source.

Information required for executing a shipping instruction for such as the shipping date, the number of shipping units and the packaging form is determined on the basis of a shipping request from the supply destination and a supply available schedule of the supply source, when shipping the goods/products from the supply source to the supply destination.

The shipping request includes information such as a shipping request due date and the number of shipping request units for the products as a shipping request target. The supply available schedule includes information such as a supply available date and the number of supply available units for supply available products.

A shipping instruction decider determines the shipping date and the number of shipping units for the products to be subject to the shipping request while satisfying a restriction of the supply available date and the number of supply available units, in such a way that the number of requested shipping units is shipped by the time of the shipping request due date There are many cases where the shipping request for certain products is executed in a day in the gross or in several days in a divided manner.

At a time of the shipping, the products is packed to then be transported. It is required that an appropriate packaging box is selected in accordance with their sizes and the number of units of the shipping products when there are a plurality of sizes of the packaging boxes. If the products to be shipped are not packed in one packaging box, the plurality of packaging boxes are used to be shipped. Further, there are various forms (packaging form) of packaging the products such that one sort of products is packed in one packaging box and a plurality of sorts of the product are combined to be packed.

The shipping instruction decider instructs to combine the packaging forms from among a plurality of packaging forms in accordance with the products to be shipped and its number of shipping units and ship them. Here, packaging supplies to be used and works required for the packing are different, and a packaging supply cost and packaging work cost are also different from which of the packaging forms is selected. Further, since volume and weight are also different after packing the products, expenditures for such as an airfare etc are also different depending on them. For this reason, it is desired that the packaging form is selected so as to make the cost minimum.

### SUMMARY OF THE INVENTION

However, the selection of packaging form varies in accordance with the number of shipping units depending on which of the packaging forms is selected. When there are a plurality of numbers of combination for the shipping date and the number of shipping units so as to satisfy the shipping request and supply available schedule, the selectable packaging form is also varied depending on which of the combinations of shipping date and number of shipping units is selected.

For this reason, it is required to determine an optimum shipping date, the number of shipping units and packaging form so that a physical distribution cost is reduced.

JP-A-2004-264959 discloses a method of determining the shipping date and the number of shipping units when using containerized transportation by a railway by bringing forward a shipping date if there is an empty space in a container such that the empty space in the container becomes little. However, in the JP-A-2004-264959, it assumes that the products are loaded up in the same size of the container, therefore, this related art takes a method of bringing forward a shipment if there is the empty space, as the method of shipping the products effectively. In contrast, when there are a plurality of sizes of containers (or packaging boxes), it is possible to handle various cases such that the combination of packaging forms is changed or the shipment is brought forward to then change the combination of the packaging form, other than the shipment is merely brought forward. For this reason, the combination which makes the cost minimum cannot be selected from only by that the shipment is brought forward to fill the empty space.

JP-A-2005-284996 discloses that an estimation is executed by using quantification data for the case where components to be a shipping target are divided into a plurality of shipping component units or the shipping component units to be the shipping target are packed together, to then determine an optimum packaging form. However, JP-A-2005-284996 determines the packaging form for the already determined number of units. For this reason, the optimum packaging form cannot be determined at a time when the number of shipments is not determined yet.

An object of the invention is, at instruction of a shipment from the supply source to the supply destination, to provide a shipping instruction determination system and a method for selecting a shipping date, the number of shipping units and a packaging form so as to make a physical distribution cost minimum, on the basis of a supply available schedule of a supply source, a shipping request of a supply destination and the physical distribution cost for every packaging form.

The shipping instruction determination system and a method in the invention is configured by the following configuration.

According to an aspect of the invention, the shipping instruction determination system provides: a storage device that stores a shipping request in a supply destination, a supply available schedule of a supply source, information of a packaging form indicating a combination of products and its number of units to be able to be packed in packaging boxes to be used for a shipment and a physical distribution cost for every packaging form; and a shipping instruction calculation unit that calculates a combination of a shipping date, the number of shipping units and a packaging form, a physical distribution cost of which becomes minimum, from among the shipping available combinations of the shipping date, the number of shipments and the packaging form, from the shipping request, the supply available schedule, the information of packaging form and the physical distribution cost for every packaging form, to determine a shipping instruction.

According to the invention, the shipping instruction determination system is implemented for selecting the shipping date, the number of shipments and the packaging form as a combination, the physical distribution of which becomes minimum, on the basis of the supply available schedule of the supply source, the shipping request of the supply destination, the information of packaging form and the physical distribution cost for every packaging form, in the shipping instruction of the product from the supply source to the supply destination.

The other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram representing a functional configuration of a shipping instruction determination system 100 in relation to one embodiment of the invention;

FIG. 2 is a configuration diagram representing another functional configuration of the shipping instruction determination system 100 using one example of a shipping instruction calculation unit in the embodiment;

FIG. 3 is a flowchart representing a shipping instruction determination in the embodiment;

FIG. 4 is a table representing one example of shipping request data in the embodiment;

FIG. 5 is a table representing one example of supply available schedule data in the embodiment;

FIG. 6 is a table representing one example of a packaging form in the embodiment;

FIG. 7 is a table representing one example of a physical distribution cost master each of the packaging forms in the embodiment;

FIG. 8 is a flowchart representing a calculation for the shipping instruction determination in the embodiment;

FIG. 9 is a sequence diagram representing a calculation process for the shipping instruction determination in the embodiment;

FIG. 10 is a flowchart representing a calculation process for a shipping available combination in the embodiment;

FIG. 11 is a diagram representing one example of a shipping target date selection screen in the embodiment;

FIG. 12 is a table representing shipping available combination data in the embodiment;

FIG. 13 is a table representing one example of physical distribution cost data for each of the shipping available combinations in the embodiment; and

FIG. 14 is a table representing one example of shipping instruction data in the embodiment.

### DETAILED DESCRIPTION OF THE EMBODIMENTS

An embodiment of the invention will be described with reference to the drawings.

This embodiment indicates an example of an apparatus or system for determining a shipping instruction of combining a plurality of packaging forms and shipping them while adjusting a shipping time schedule, when the products are shipped from a supply source to a supply destination in response to a request from the supply destination. At a time of determining the shipping instruction, it considers a case where a shipping date, the number of shipping units and a packaging form are determined by receiving a supply available product, the number of supply available units and a supply available date from the supply source, and a shipping request product, the number of shipping request units and a shipping request due date from the supply destination.

In addition, this embodiment will be described assumedly with a case where two types of product are shipped for the sake of simplicity, however, the types of product may be three of more.

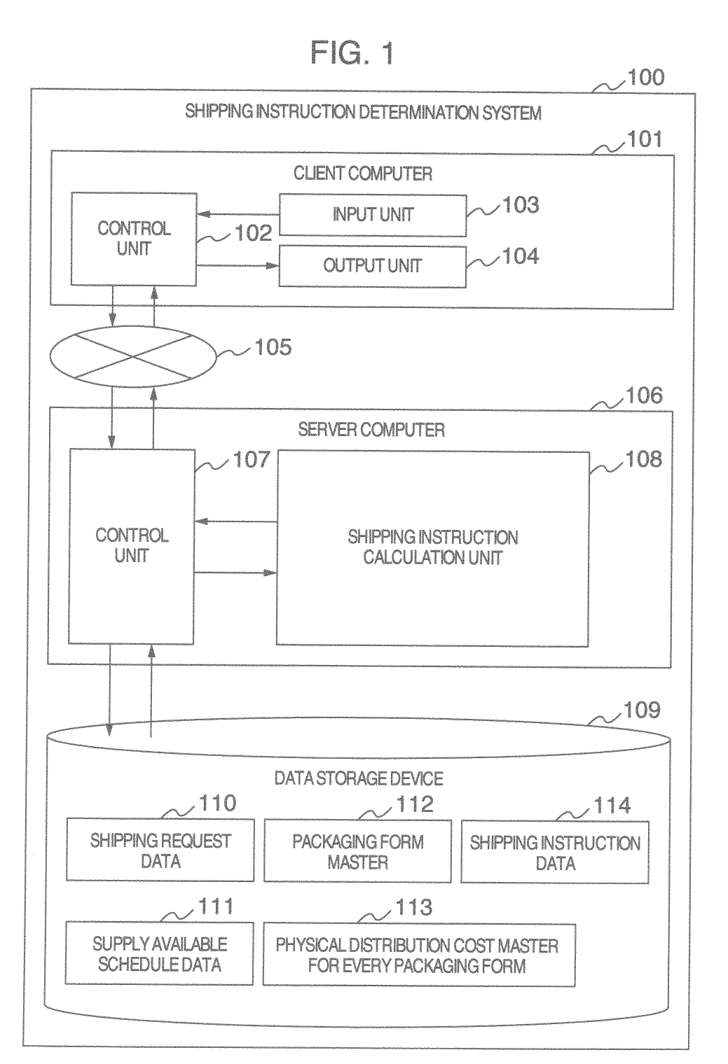

FIG. 1 is a configuration diagram representing a shipping instruction determination system 100 in this embodiment.

As represented in FIG. 1, the shipping instruction determination system 100 provides a client computer 101, a server computer 106, a communication network 105 connected between the client computer 101 and server computer 106, and a data storage device 109.

The client computer 101 provides a control unit 102, an input unit 103 and an output unit 104 therein.

The control unit 102 in the client computer 101 executes the entire control of the client computer 101. Specifically, the control unit 102 acts as transmitting data and files accepted by the input unit 103 to the server computer 106 through the communication network 105 and receiving shipping instruction data 114 transmitted from the server computer 106 to transfer to the output unit 104.

The input unit 103 accepts an input, such as data to be stored in the data storage device 109, an execution instruction of a process, etc from a user. In this embodiment, the input unit 103 accepts an input, such as shipping request data 110, supply available schedule data 111 regarding supply information, a packaging form master 112 and a physical distribution cost master for every packaging form 113. It also accepts an execution instruction of the process regarding a shipping instruction determination.

In addition, the user used in this invention indicates a person in charge of determining the shipping instruction in a production supervisory section and a physical distribution section.

The output unit 104 in the client computer 101 outputs data in accordance with an instruction from the control unit 102. For example, the shipping instruction is displayed on a screen, or printed.

The seder computer 106 provides a control unit 107 and a shipping instruction calculation unit 108.

The control unit 107 in the server computer 106 controls the server computer 106 entirely. In this embodiment, the control unit 107 receives data transmitted from the client computer 101 through the communication network 10 to transfer to the data storage device 109. The control unit 107 also reads out the input data from the data storage device 109 to then transfer to the shipping instruction calculation unit 108. The control unit 107 further receives shipping instruction data 114, as a processed result, to transfer to the data storage device 109 and also transmit to the client computer 101 through the communication network 105

The shipping instruction calculation unit 108 in the server computer 106 determines a combination of the shipping date, the number of shipping units and the packaging form so as to make a physical distribution cost minimum, from the input data transferred from the control unit 107 to then transfer the shipping instruction data 114, being the processed result, to the control unit 107

The data storage device 109 stores the input data transferred from the control unit 107 in the server computer 106, transfers the data required for the process to be executed in processing units in the server computer 106, and stores the data of the processed result generated in the server computer 106. The data storage device 109 stores at least the shipping request data 110, supply available schedule data 111, packaging form master 112, physical distribution cost master for every packaging form 113 and shipping instruction data 114. The respective pieces of data to be stored in the data storage device 109 will be described in part of an after-mentioned calculation process.

In the above-mentioned configuration, the invention is implemented by executing a predetermined process in the client computer 101 and the server computer 106. Here, the data storage device 109 may be located in either the server computer 106 or the client computer 101.

In addition, even though the input unit 103 and the output unit 104 located in the client computer 101 are located in the server computer 106, the invention may also be implemented by executing the process equivalent to the control unit 102 in the control unit 107 without via the communication network 105. Further, if there would be a plurality of client computers 101, the invention may be implemented by executing the program in the server computer 106 from a plurality of users. The invention is further implemented by using a screen display application, such as Java (registered trademark), on a screen in the case where the input unit 103 in the client computer 101 executes a necessary process on the screen for which the input operation is executed.

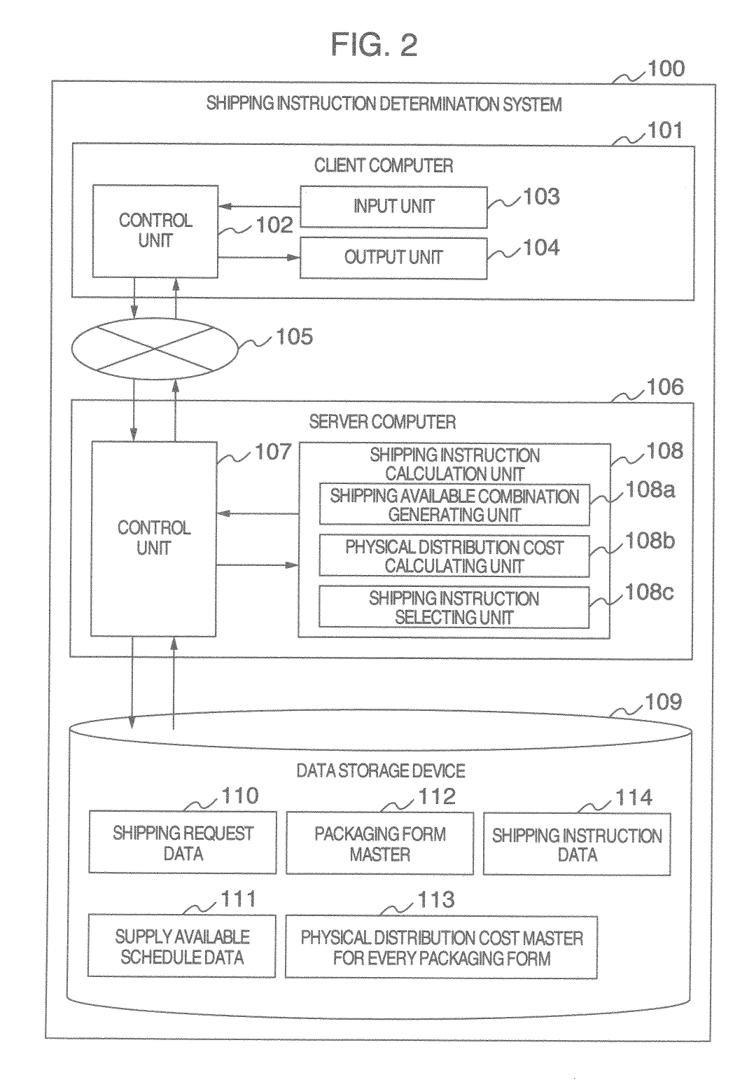

FIG. 2 is a configuration diagram representing a functional configuration of the shipping instruction determination system 100 using the shipping instruction calculation unit 108 as one example illustrated in detail, in this embodiment. The example in FIG. 2 will be described below.

The shipping instruction calculation unit 108 provides a shipping available combination generating unit 108a, a physical distribution cost calculating unit 108b and a shipping instruction selecting unit 108c.

The shipping available combination generating unit 108a calculates a combination of the shipping date and the packaging form to be able to shipped, from the input data transferred from the control unit 107 to then transfer shipping available combination data, being a processed result, to the control unit 107.

The physical distribution cost calculating unit 108b calculates a physical distribution Lost for every shipping available combination from the input data transferred from the control unit 107 to then transfer physical distribution cost data of the shipping available combination, being a processed result, to the control unit 107.

The shipping instruction selecting unit 108c selects a shipping available combination, the physical distribution cost of which becomes minimum, from the input data transferred from the control unit 107 to then transfer the shipping instruction data 114, being a processed result, to the control unit 107.

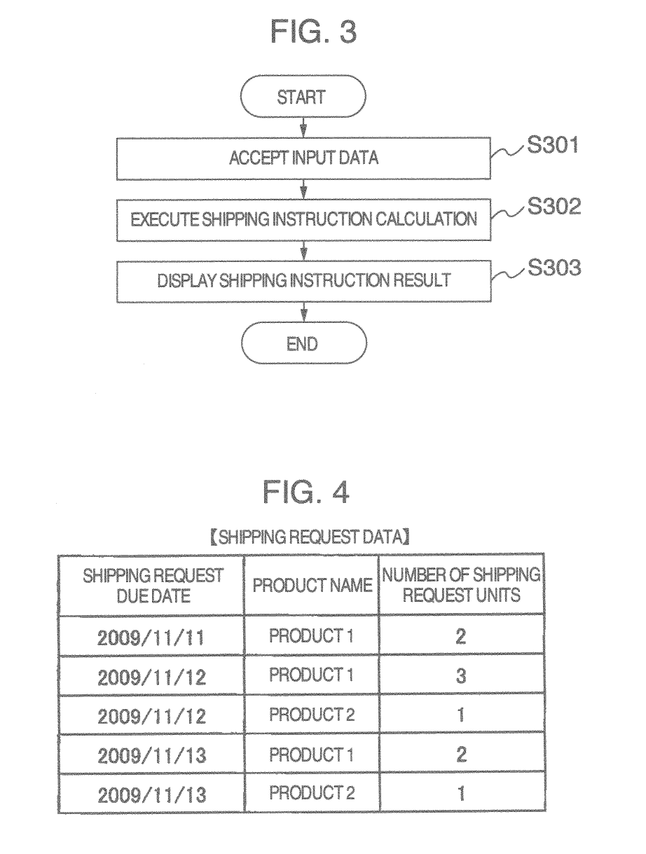

FIG. 3 is a flowchart representing a process of the shipping instruction determination in the system. Hereinafter, the process will be described with reference to FIG. 3

First, the process executes an input data acceptance at a step S301.

The input unit 103 accepts the shipping request data 110, supply available schedule data 111, packaging form master 112 and physical distribution cost master for every packaging form 113.

The shipping request data 110 is data regarding a shipping request from the supply destination. FIG. 4 lists one example of the shipping request data 110. As represented in FIG. 4, the shipping request data 110 contains, at least, product names requested with a shipping request from the supply destination to the supply source, shipping request due dates as dates at which the product should be shipped at the latest, and the number of shipping request units.

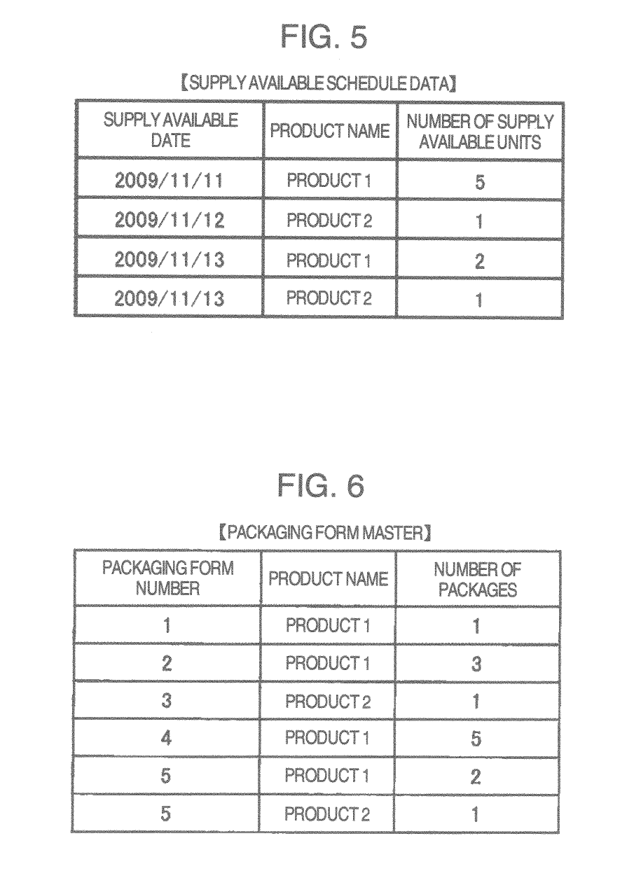

The supply available schedule data 111 is data regarding the supply available schedule of the supply source. FIG. 5 lists one example of the supply available schedule data 111. As represented in FIG. 5, the supply available schedule data 111 contains, at least, product names to be able to supply from the supply source to the supply destination, supply available dates, and numbers of supply available units.

The packaging form master 112 is data regarding a combination of the product and its number of units to be able to be packed in each of the packaging boxes to be used for the shipping. FIG. 6 lists one example of the packaging form master 112. As represented in FIG. 6, the packaging form master 112 contains, at least, packaging form numbers indicating the combination of the product and its number of units to be able to be packed in one box, product names to be packed in the packaging box corresponding to the packaging form numbers, and numbers of packages. It is represented that the products having the same packaging form number are packed in the same packaging box. In FIG. 6, the packaging form number 1 represents that one unit of the product 1 is packed as one package. The packaging form number 2 represents that three units of the product 1 are packed as one package. The packaging form number 5 represents that two units of the product 1 and one unit of the product 2 are packed.

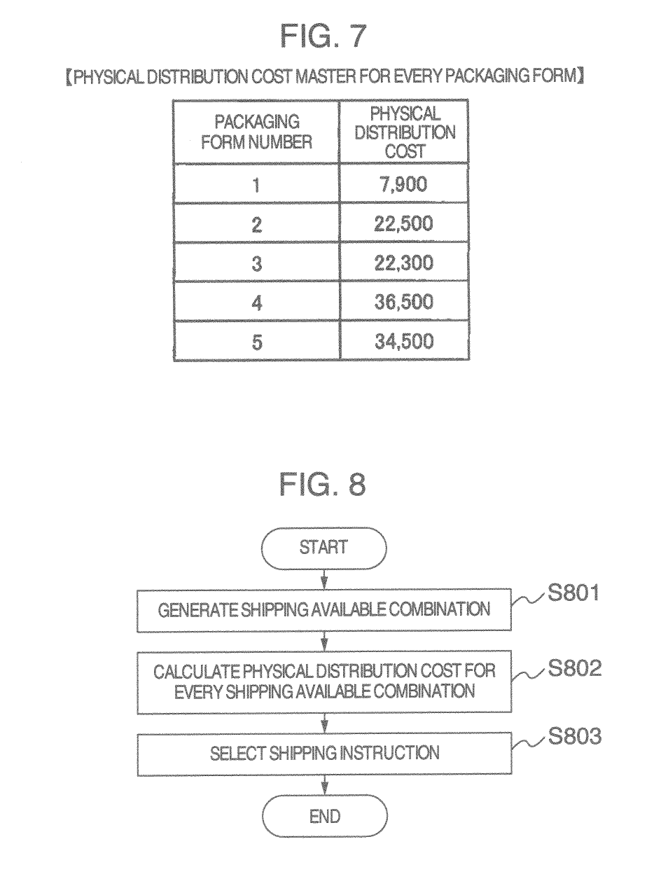

The physical distribution cost master for every packaging form 113 is data regarding the physical distribution cost for every packaging form. FIG. 7 shows one example of the physical distribution cost master for every packaging form 113. As represented in FIG. 7, the physical distribution cost for every packaging form 113 contains the packaging form number and the physical distribution cost for every packaging form number.

The control unit 102 in the client computer 101 transmits the data and file accepted at the input unit 103 to the server computer 106 through the communication network 105. The control unit 107 in the server computer 106 receives the data transmitted from the client computer 101 to then transfer to the data storage device 109 through the communication network 105. The data storage device 109 then stores the data.

Next, the process executes a shipping instruction calculation at a step S302 (FIG. 3).

The input unit 103 accepts the instruction of executing the process of shipping instruction calculation, and the control unit 102 in the client computer 101 transmits the execution instruction of the shipping instruction calculation process to the server computer 106 through the computer network 105. The control unit 107 in the server computer 106 receives the instruction to start a calculation process for determining the shipping instruction.

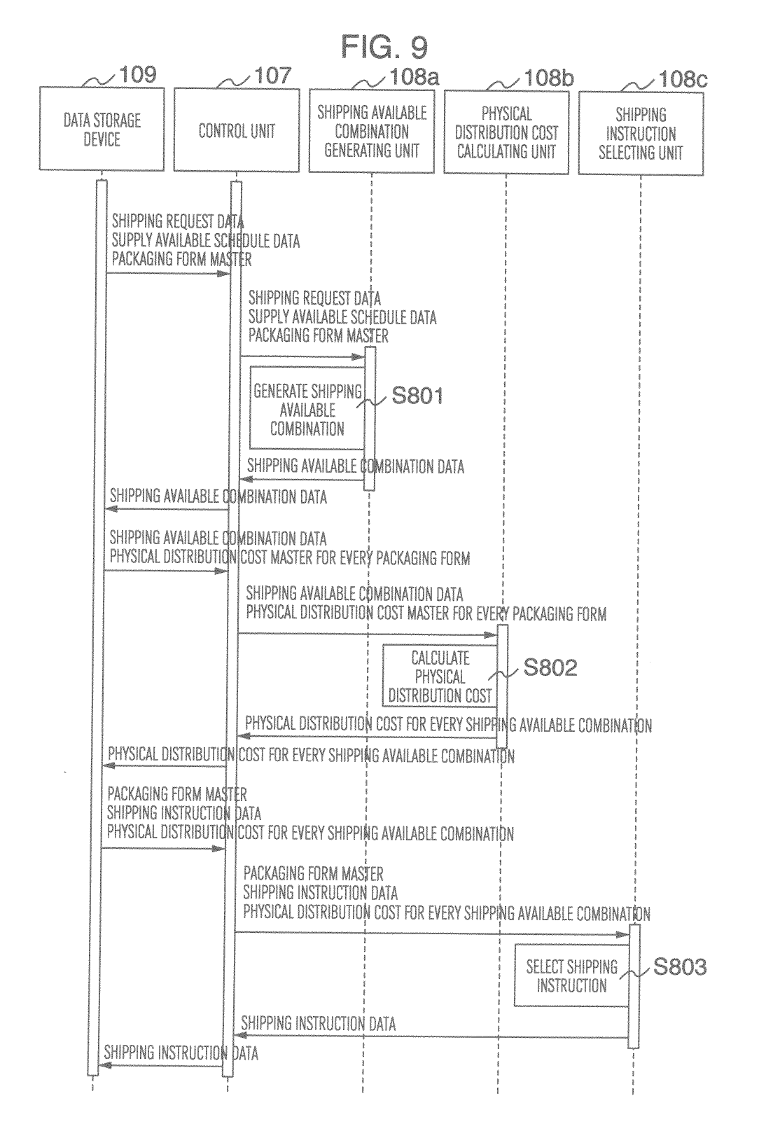

FIG. 8 is a flowchart representing a calculation process for determining the shipping instruction. FIG. 9 is a sequence diagram representing in what order each process represented in FIG. 8 is executed in each component located in the system. Hereinafter, the above-mentioned processes will be described with reference to FIG. 8.

The process executes to generate a shipping available combination at a step S801.

The control unit 107 in the server computer 106 reads out the shipping request data 110, supply available schedule data 111 and packaging form master 112 from the data storage device 109 to transfer to the shipping available combination generating unit 108a in the shipping instruction calculation unit 108.

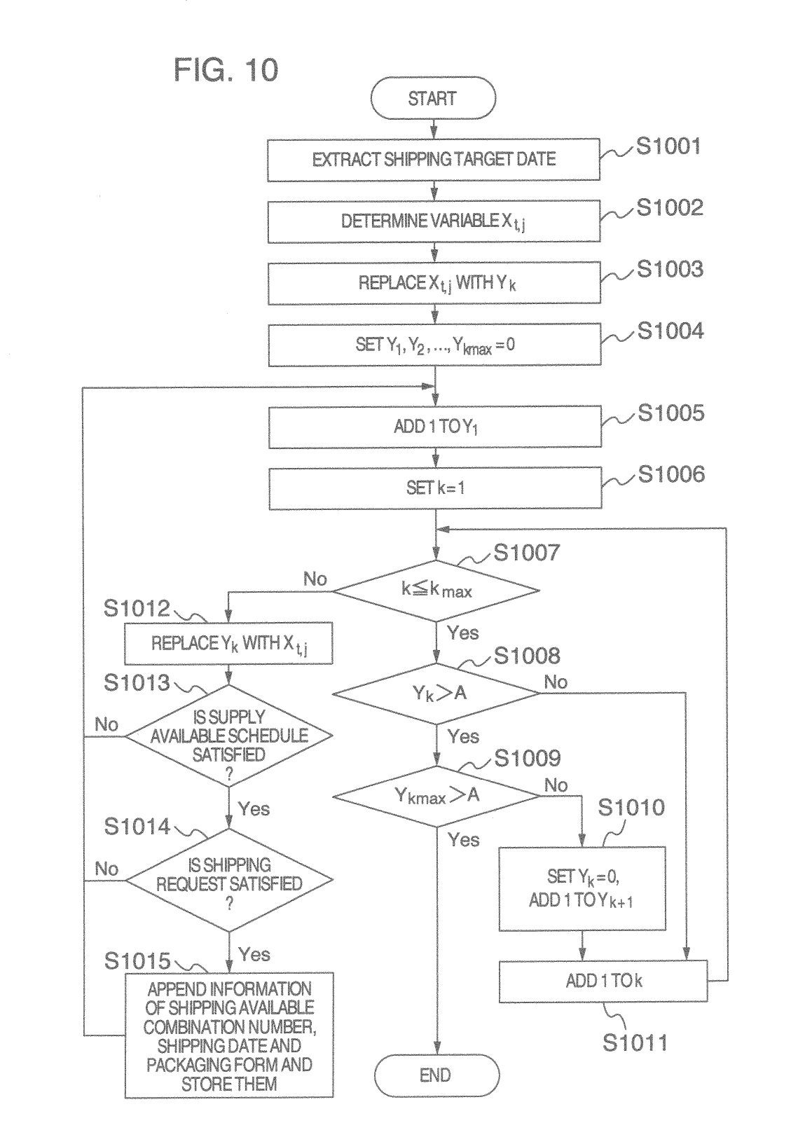

The shipping available combination generating unit 108a generates the shipping available combination of the shipping date and the packaging form in accordance with the instruction from the control unit 107. FIG. 10 is a flowchart of a calculation process for the shipping available combination in this embodiment, and the calculation process will be described below.

First, the process executes an extraction for a shipping target date at a step S1001.

The shipping available combination generating unit 108a extracts an earliest supply available date as a shipping target start date in a supply available date in the supply available schedule data 111 and a latest shipping request due date as a shipping target end date in the shipping request due date in the shipping request data 110 to then convert the shipping target start date to the shipping target end date into t=1, 2, . . . , tₘₐₓ in order of date. For example, Nov. 11, 2009 being the earliest supply available date becomes the shipping target start date, and Nov. 13, 2009 lists the latest shipping request due date becomes the shipping target end date, in this embodiment. November 11, November 12, and Nov. 13, 2009 are therefore converted into t=1, 2, 3 in order.

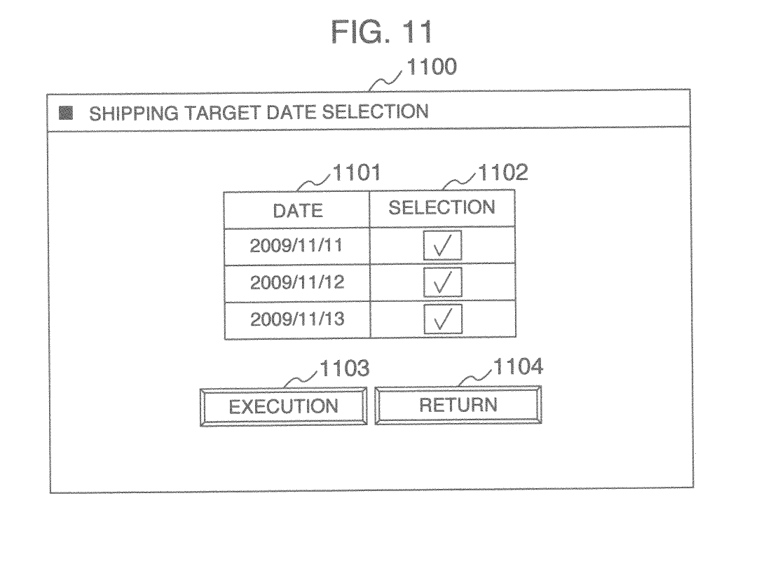

At the step S1001, the shipping target date can also be selected. For example, the shipping available combination generating unit 108a extracts all of the dates for the supply available date in the supply available schedule data 111 and the shipping request due date in the shipping request data 110. Here, shipping target date selection screen data is transmitted to the client computer 101 through the communication network 105 so that a selection of the shipping target date is accepted. In the client computer 101, a shipping target date selection screen 1100 (FIG. 11) generated from the shipping target date selection screen data is displayed on the output unit 104.

FIG. 11 represents one example of the shipping target date selection screen 1100. As represented in FIG. 11, the shipping target date selection screen 1100 contains a date column 1101 indicating a date becoming an option for the shipping target, a selection column for accepting the selection of the shipping target date, an execution button 1103 for accepting the instruction to transmit the input contents to the server computer 106, and a return button 1104 for making the instruction entered on the screen invalid to then accept the instruction for returning to the previous process.

The shipping target date is selected on the shipping target date selection screen 1100 and the execution button 1103 is depressed. Shipping target date data is then transmitted to the server computer 106 via the communication network 105. The control unit 107 in the server computer 106 receives the shipping target date data to then transfer to the shipping available combination generating unit 108a. The shipping available combination generating unit 108a converts the shipping target date in the shipping target date data to t=1, 2, . . . , tₘₐₓ in order of date.

Next, at a step S1002, variables are determined for the number of shipments or every packaging form in each of the shipping dates. Here, it assumes that the number of shipments for a packaging form number j (j=1, 2, . . . , jₘₐₓ) at a shipping date t is set to X_{t,j}. For example, the shipping target date t=1, 2, 3 and the packaging form number j=1, 2, 3, 4, 5 are given in this embodiment, therefore, the variables are set to X_{1, 1}, X_{1, 2}, X_{1, 3}, X_{1, 4}, X_{1, 5}, X_{2, 1}, X_{2, 2}, X_{2, 3}, X_{2, 4}, X_{2, 5}, X_{3, 1}, X_{3, 2}, X_{3, 3}, X_{3, 4}, X_{3, 5}.

At a step S1003, the variable Xₜ is converted to Yₖ. In this regard, k=(t−1)×J[=jₘₐₓ]+j, k=1, 2, . . . , kₘₐₓ is given, and it becomes kₘₐₓ=tₘₐₓ×jₘₐₓ. For example, the variables X_{1, 1}, X_{1, 2}, . . . , X_{3, 5} are converted to Y₁, Y₂, . . . , Y₁₅. Therefore, kₘₐₓ becomes 15.

At a step S1004, all of Yₖ is set to 0 so that initialization is executed.

At a step S1005, 1 is added to Y₁.

At a step S1006, k=1 is set.

At a step S1007, the process determines whether k is equal to or less than kₘₐₓ, The process proceeds to a step S1008 if k is equal to or less than kₘₐₓ. If k is not equal to or less than kₘₐₓ, the process proceeds to a step S1012. In the example of this embodiment, the process determines whether k is equal to or less than 15. If k is equal to or less than 15, the process proceeds to the step S1008, and to the step S1012 if k is not equal to or less than 15

At the step S1008, the process determines whether the number (Yₖ) of shipments for every packaging form in each of the shipping dates is greater than a threshold value A. The threshold value A is set to a value equal to or greater than the utmost value of the variable Yₖ. For example, the variable Yₖ is set surely to a smaller value than the number of packaging form shipments of the case where one unit is packed by every package, by gathering the number of shipping request units of a product i in a day. Therefore, a sum Sᵢ of totalizing the number of shipping request units of the products i for a targeted time period is calculated to then set the largest Sᵢ among all of the products i to the threshold value A. The process proceeds to a step S1009 if the variable Yₖ is greater than the threshold value A, and proceeds to a step S1011 if Yₖ is not greater than the threshold value A. In the example of this embodiment, the sum of the number of shipping request units of the product 1 is seven units and the sum of the number of shipping request units of the product 2 is two units, therefore, the threshold value is set to A=7. The process proceeds to the step S1009 if the variable Yₖ is greater than 7, and to the step S1011 if Yₖ is not greater than 7.

At the step S1009, the process determines whether the last variable Yₖₘₐₓ of Yₖ is greater than the threshold value A. The threshold value A may be the same value as that used in the step S1008. If Yₖₘₐₓ is greater than the threshold value A, the process is terminated, and proceeds to a step S1010 if Yₖ is not greater than the threshold value A. In the example of this embodiment, the process determines whether Y15 is greater than 7. If Y15 is greater than the threshold value 7, the process is terminated, and proceeds to the step S1010 if Y15 is not greater than the threshold value 7.

At the step S1010, Yₖ=0 is set, and 1 is added to Yₖ₊₁.

At the step S1011, 1 is added to k.

At the step S1012, the variable Yₖ is returned to X_{t,j} on the basis of the step S1003.

At a step S1013, the process determines whether a condition of the supply available schedule is satisfied. It can be determined that the supply available schedule is satisfied if the number of cumulative shipping units is equal to or less than the number of cumulative supply available units by the time of the shipping date t, as set the shipping date t for all of the products i. The process proceeds to a step S1014 if the condition of supply available schedule is satisfied, and returns to the step S1005 if the condition of supply available schedule is not satisfied.

At the step S1014, the process determines whether a condition of the shipping request is satisfied. It can be determined that the condition of shipping request is satisfied if the number of cumulative shipping units is equal to or greater than the number of cumulative shipping requests by the time of the shipping date t, for all of the shipping date t and the products i. The process proceeds to a step S1015 if the condition of shipping request is satisfied, and proceeds to the step S1005 if the condition of supply available schedule is not satisfied.

At the step S1015, a combination of the variable X_{t,j} is stored. At this time, the shipping available combination number is appended to the combination in order of the stored combinations. Further, the shipping date and packaging form number information are appended to the combination in accordance with the variable X_{t,j} of the number of shipments for every packaging form in each of the shipping dates. For example, if the variable is X_{1, 1}, the information of a shipping date Nov. 11, 2009 and a packaging form number 1 is appended to the combination. The process proceeds to the step S1005 when terminating the storage.

With the above-mentioned process, the shipping available combination data is generated such that it has the shipping available combination number, a variable name representing the number of shipments for every packaging form in each of the shipping dates, the shipping date, the packaging form number and the number of packaging form shipments.

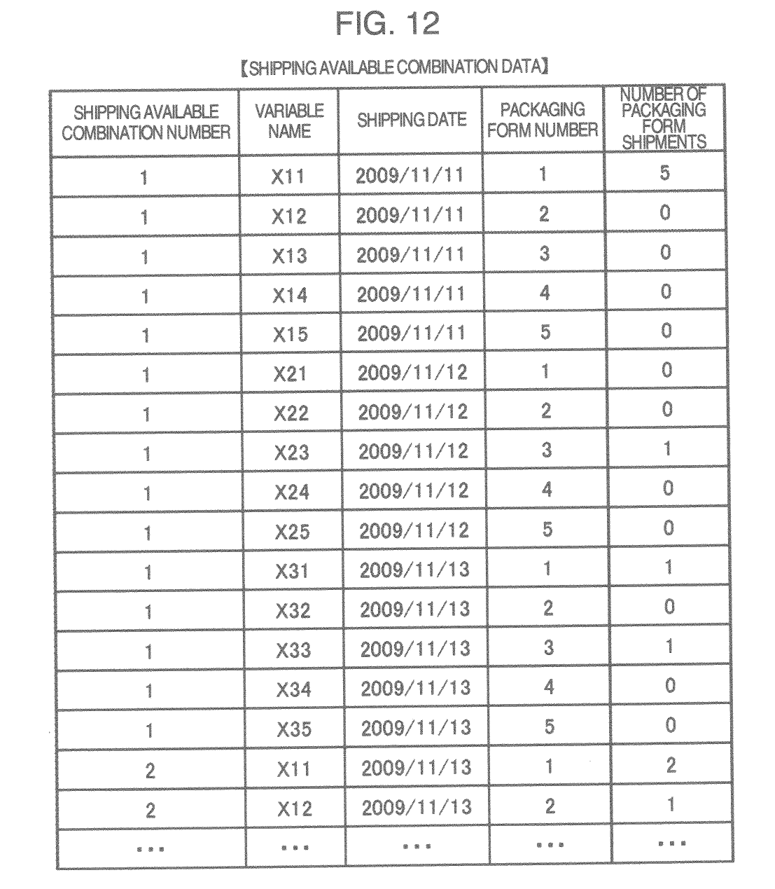

FIG. 12 lists one example of the shipping available combination data. As represented in FIG. 12, the shipping available combination data contains, at least, shipping available combination numbers, variable names representing the number of shipments for every to packaging form in each of the shipping dates, shipping dates, packaging form numbers and numbers of packaging form shipments. In FIG. 12, the same shipping available combination number means that it indicates one combination. In the example of this embodiment, the shipping available combination number 1 indicates a combination such that the variable X_{1, 1} is 5, X_{2, 3} is 1, X_{3, 1} is 1, X_{3, 3} is 1 and the other is 0.

The control unit 107 in the server computer 106 reads out the shipping available combination data from the shipping available combination generating unit 108a to transfer to the data storage device 109.

The data storage device 109 stores the shipping available combination data temporarily.

Next, the process executes the physical distribution cost calculation for each of the shipping available combinations at a step S802 (FIG. 8).

The control unit 107 in the server computer 106 reads out the shipping available combination data and the physical distribution cost master for every packaging form 113 from the data storage device 109 to transfer to the physical distribution cost calculating unit 108b in the shipping instruction calculation unit 108.

The physical distribution cost calculating unit 108b calculates a physical distribution cost for each of the shipping combination numbers in the shipping available combination data to then generate physical distribution cost data for each of the shipping available combinations. The physical distribution cost can be calculated such that the physical distribution cost for every packaging form is multiplied by the number of packaging form shipments for each of the packaging form numbers and this result is totalized for each of the shipping available combinations.

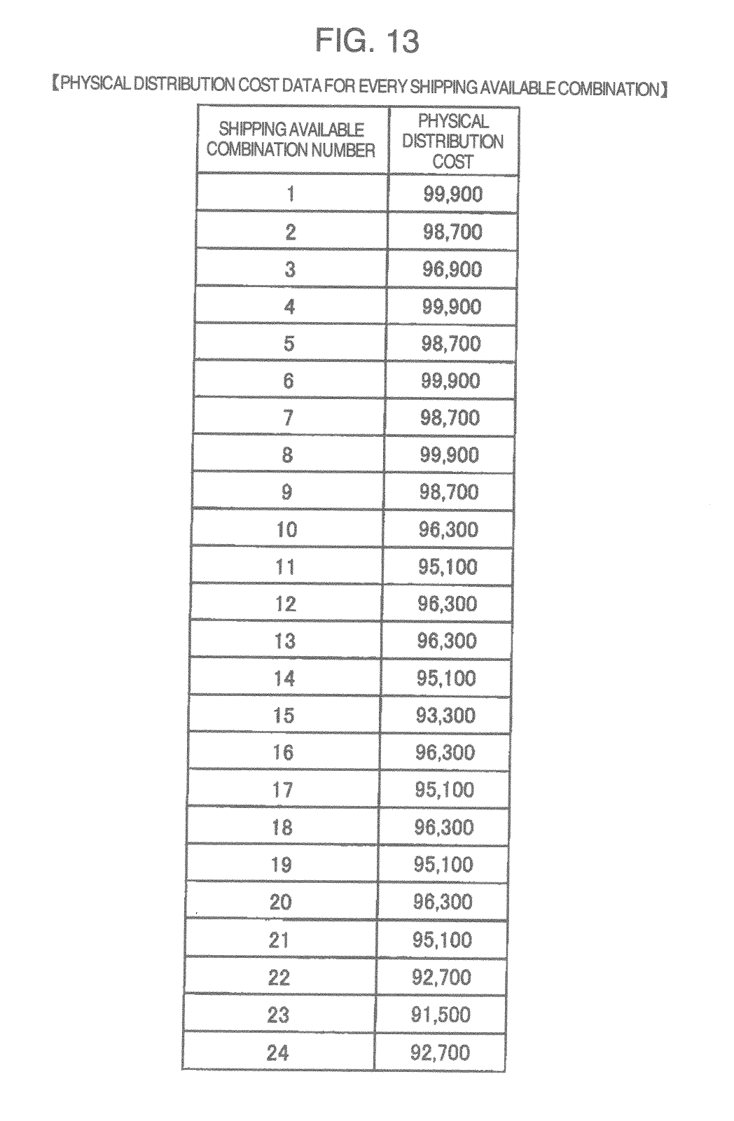

FIG. 13 lists one example of the physical distribution cost data for each of the shipping available combinations. As represented in FIG. 13, the physical distribution cost data for each of the shipping available combinations contains, at least, data of the shipping available combination number in the shipping available combination data and the physical distribution cost for each of the shipping available combination numbers.

The control unit 107 in the server computer 106 reads out the physical distribution cost data for each of the shipping available combinations from the physical distribution cost calculating unit 108b to transfer to the data storage device 109.

The data storage device 109 temporarily stores the physical distribution cost data for each of the shipping available combinations.

Next, the process executes a shipping instruction selection at a step S803 (FIG. 8)

The control unit 107 in the server computer 106 reads out the packaging form master 112, shipping available combination data and physical distribution cost data for each of the shipping available combinations from the data storage device 109 to transfer to the shipping instruction selecting unit 108c in the shipping instruction calculation unit 108.

The shipping instruction selecting unit 108c extracts the shipping available combination number, which makes the physical distribution cost for each of the shipping available combinations minimum, from the physical distribution cost data for each of the shipping available combinations. Next, shipping dates, packaging form numbers and numbers of packaging form shipments corresponding to the extracted shipping available combination numbers are extracted from the shipping available combination data to then append a shipping instruction number to each one of the shipments for the packaging form, Next, a product name corresponding to the packaging form number and the number of packages are extracted from the packaging form master 112. The extracted number of packages corresponds to the number of shipping units for one shipping instruction. In this way, the shipping instruction data 114 is generated such that it contains the shipping instruction number, shipping date, packaging form number, product name and the number of shipping units.

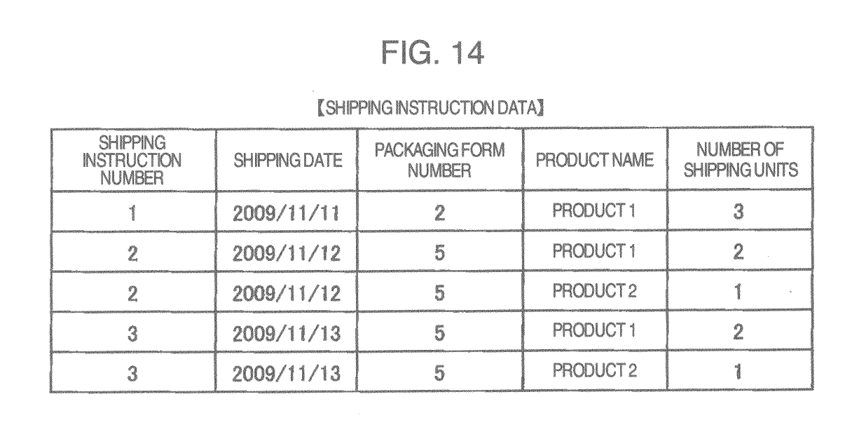

In the example of this embodiment, the shipping available combination number “23”, the physical distribution cost of which becomes minimum in FIG. 13, is extracted. The shipping instruction data 114 is then generated from the shipping available combination data corresponding to the extracted shipping available combination number “23” and the packaging form master 112. FIG. 14 lists one example of the shipping instruction data. As represented in FIG. 14, the shipping instruction data 114 contains, at least, shipping instruction numbers indicating shipping instruction units, shipping dates, packaging form numbers, product names and numbers of shipments. FIG. 14 represents an instruction indicating that three units of the product 1 packed by the packaging form of packaging form number 2 are shipped on Nov. 11, 2009 as a shipping instruction number 1, two units of the product 1 and one unit of the product 2 packed by the packaging form of a packaging form number 5 are shipped on Nov. 12, 2009 as a shipping instruction number 2, and two units of the product 1 and one unit of the product 2 packed by the packaging form of packaging form number 5 are shipped on Nov. 13, 2009 as a shipping instruction number 3.

At the step S803, if there is not only one shipping available combination, the physical cost of which becomes minimum, but also a plurality of combinations, a priority rule. For can be set to extract the shipping available combination on the basis of the priority rule. For example, there are a method that a difference from the supply available date is calculated for all of the products to then select a shipping available combination in which a total difference is low, a method that a difference from the shipping request due date is calculated for all of the products to then select a shipping available combination in which a total difference is low, and so forth.

The control unit 107 in the server computer 106 reads out the shipping instruction data 114 from the shipping instruction selecting unit 108c to transfer to the data storage device 109.

In this way, the execution of the shipping instruction calculation at the step S302 is terminated.

The shipping instruction calculation at the step S302 may execute such that all of the combinations for the shipping available elements such as the shipping date, number of shipping units and packaging form are enumerated in the shipping instruction calculation unit 108, as described in this embodiment, to then compare the physical distribution costs with each other for each of the shipping available combinations, and may also execute a calculation for the shipping available combination, the physical distribution cost of which becomes minimum, in the shipping instruction calculation unit 108, as an integer programming problem in which a solving method such as a branch and bound method has been established.

Next, the process executes a display of a shipping instruction result of a step S303 (FIG. 3).

The control unit 107 in the server computer 106 reads out the shipping instruction data 114 from the data storage device 109 to transmit to the client computer 101 through the communication network 105.

The control unit 102 in the client computer 101 receives the shipping instruction data 114 transmitted from the server computer 106 to transfer to the output unit 104.

The output unit 104 outputs the data in accordance with an instruction from the control unit 102. For example, the shipping instruction is displayed on a screen or printed out.

As mentioned above, according to the shipping instruction determination system in the embodiment, the physical distribution cost can be reduced by supporting the determination of the shipping instruction which makes the physical distribution cost minimum, while satisfying the shipping request and supply available schedule. The shipping instruction determination system can be used for the shipping instruction in the case where there are a plurality of packaging forms, and can also be used for a shipping schedule service, a shipping instruction service, etc. in general manufacturers, distribution services, physical distribution services, etc.

It should be further understood by those skilled in the art that although the foregoing description has been made on embodiments of the invention, the invention is not limited thereto and various changes and modifications may be made without departing from the spirit of the invention and the scope of the appended claims.

1. A shipping instruction determination system configured by connecting: a client computer which provides a man-machine interface for a shipping source of products, a shipping destination of the products and/or users which determines a shipping instruction to accept various data and instructions from an input unit and output a shipping instruction data from an output unit; with a server computer which provides a shipping instruction calculation unit for generating shipping instruction data, a physical distribution cost of which becomes minimum, from the various input data and a storage device which stores the various input data and calculated result data, via a network; wherein
the storage device stores a shipping request of the supply destination, a supply available schedule of the supply source, master information of a packaging form as a combination of the products and its number of units to be able to be packed in each of packaging boxes to be used for a shipment, another master information of the physical distribution cost for every packaging form, and the shipping instruction data acquired by the calculation, and
the shipping instruction calculation unit calculates a combination, the physical distribution cost of which becomes minimum, from among all of the combinations of a shipping available shipping date, number of shipping units and the packaging form, from the shipping request, the supply available schedule, the master information of the packaging form and the another master information of the physical distribution cost for every packaging form, to generate the shipping instruction data containing information of the shipping date, a packaging form number, a product name and the number of shipping units.

2. The system according to claim 1, wherein the shipping instruction calculation unit includes:
a shipping available combination generating unit which generates a shipping available combination of the shipping date and the packaging form, from the information of the shipping request, the supply available schedule and the packaging form;
a physical distribution cost calculating unit which calculates the physical distribution cost for every shipping available combination, from the shipping available combination and the physical distribution cost for every packaging form; and
a shipping instruction selecting unit which selects the shipping available combination, the physical cost of which becomes minimum, from the master information of the packaging form, the shipping available combination and the physical distribution cost for every shipping available combination, and generate the shipping instruction data containing information of the shipping date, the packaging form number, the product name and the number of shipping units.

3. The system according to claim 1, wherein the output unit in the client computer displays the shipping instruction data on a screen or prints out.

4. The system according to claim 1, wherein
data of the shipping request contains at least the product name to be subjected to the shipping request, a shipping request due date at which a shipment is executed by the time of that date at the latest and number of shipping request units,
data of the supply available schedule contains at least the product name to be supplied available from the supply source to the supply destination, a supply available date and number of supply available units,
data of the master information regarding the packaging form contains at least the product name to be packed and number of packages, and
information of the shipping available combination contains at least the shipping date, the packaging form and the number of packaging form shipments.

5. The system according to claim 2, wherein, in a process for generating the combination of the shipping date and the packaging form, the shipping available combination generating unit extracts such that an earliest supply available date in data of the supply available schedule is set to a shipping target start date and a latest shipping request due date in data of the shipping request is set to a shipping target end date, or a shipping target screen selectable for a shipping date to be a target is displayed on the output unit to accept an input of a shipping target date from the user.

6. The system according to claim 5, wherein the shipping available combination generating unit determines a variable for number of shipments for every shipping target date and packaging form to satisfy the supply available schedule for the respective variables and for all of the combinations assigned with all of integers from 0 to a maximum threshold value A of number of the packaging form shipments, and extract and store a shipping available combination satisfying the shipping request.
